(19) United States
(12) Patent Application Publication
(10) Pub. No.: US 2013/0340302 A1
(43) Pub. Date: Dec. 26, 2013

(54) APPARATUS FOR SECURING PHOTOGRAPHS WITHIN A DISPLAY BOARD

(71) Applicant: Patrick Kinnamon, Fayetteville, AR (US)

(72) Inventor: Patrick Kinnamon, Fayetteville, AR (US)

(21) Appl. No.: 13/531,507

(22) Filed: Jun. 23, 2012

(51) Int. Cl. G09F 15/00

(52) U.S. Cl. 40/1

(57) ABSTRACT

A display board formed from a single mat, having tabs formed by placing cuts within the mat; the tabs serving to hold display items such as photographs. The display items loaded from the front of the display board, allowing the user to view the placement and location of the display items as they are being organized.

### BACKGROUND

Often it is desirable to hold, display, or organize thin flat items such as photographs, business card, tickets and the like.

Traditionally, a photograph is displayed in a picture frame. A standard picture frame sandwiches one or more display items between a rear panel and a glass pane or mat-board. The drawback of the traditional frame is that organizing a group of pictures together in the same frame is difficult because it is not possible to see and adjust the arrangement of pictures—prior to reassembly of the frame. This results in multiple attempts to adjust the display items in the proper order.

Another drawback of the traditional frame is slippage of display items over time. As pressure between the rear panel and glass pane is the only force holding the pictures in place, the pictures often shift over time as the frame is jostled.

An attempt to overcome the traditional display frame is the front loading frame, such as U.S. Pat. Nos. 1,836,035; 3,445,151; and 4,939,858. The benefit of a front loading frame is that the display item or arrangement of display items is in full view of the user, prior to reassembly of the frame. The drawback of such systems is that they tend to involve multiple layers of backing, retaining rings and transparent panes to hold the display items inside the frame. The number of pieces makes changing between a first display item and a second display item difficult and time consuming.

Additionally, front loading frames are generally manufactured for a specific size of photograph. This makes it necessary to buy the proper sized frame for a photograph or laboriously center it within a oversized frame.

Alternate methods of securing photographs within a photo album have also proven ineffective. Often an album uses a rigid page having a tacky surface and thin plastic covering that attaches to the page over the photograph. However, photographs often shift on a given page as the tacky surface of the page breaks down over time or the seal between the page and the plastic covering loosens.

At one time, adhesive corners have also been a popular method of arranging photographs. The adhesive corners formed right angles and were glued to mat-board or a similar structure. A photograph or display item is held at each corner. The benefit of adhesive corners is that they allow for customizing a display system to the size of a given display item. Drawbacks of the adhesive corners are that the glue breaks down over time and they are labor intensive, requiring multiple corners for each display item. An additional drawback is that the display system is not adjustable in size after the adhesive corners are attached.

### SUMMARY

The present invention comprises a display board or mat having a number of display tabs. The display tabs are created from the body of the mat, resulting in a display board that is a single piece. The tabs may hold display items or pictures by the flat edges or by the corners.

In an exemplary embodiment, there are multiple semi-circular display tabs created by die-cuts in the mat. The semi-circular tabs are arranged so that some tabs have a vertical orientation and others have a horizontal orientation. The display tabs are spaced in such a way that they conform to standard print sizes for photographs. The spacing of the tabs allows multiple display objects to be arranged on a single mat, forming a collage. Due to the thin flexible nature of photographs, the edges or corners of photographs may be placed under the tabs and retained in position. Because the photographs are mounted from the front of mat, their orientation to the mat and each other is readily apparent. This simplifies and speeds the process of designing a collage of photos.

In a second exemplary embodiment, the display tabs are not of a conventional geometric shape. Rather, they follow an ornamental design applied to the mat.

In a third exemplary embodiment, the tabs are straight lines oriented at a 45 degree angle.

### BRIEF DESCRIPTION OF DRAWINGS

FIG. 1 is plan view showing semi-circular display tabs oriented in both the vertical and horizontal directions.

FIG. 2 is a plan view showing a photograph held in display tabs by a corner and two opposing edges.

FIG. 3 is a plan view showing a photograph held in display tabs by two corners.

FIG. 4 is a plan view showing display tabs shaped to follow an ornamental design.

FIG. 5 is a plan view showing linear display tabs oriented at 45 degrees.

### DETAILED DESCRIPTION

The present invention consists of multiple cuts passing through a display board or mat to create display tabs. Display items are held in position by passing beneath one or more tabs. The display item rests against the display tab, preventing it from falling due to gravity. The display item may also be place beneath tabs in such a way that it cannot shift to the left or right.

The display board is preferably of a semi-rigid material. Such a material would be relatively easy to cut to create tabs, while allowing the tabs some spring force to apply against the display items. Such materials would include, but not be limited to, mat board, cardboard, plastic, and thin sheet metals.

The display tabs are formed from the mat, creating a display board having no moving parts. It is envisioned that the cuts creating the tabs may be created by any number of methods. These methods including, but not limited to, die cutting, laser cutting, drilling and burning. Additionally, it is envisioned that the cuts may be perforated allowing a user to select certain tabs for display items, while the others remain attached to the mat. The cuts forming the tabs may be of any thickness based an number of factors, including but not limited to: the size, thickness, and weight of the display item(s).

Further, it is envisioned that the tabs may be in any shape, size or orientation. Examples of such shapes include, but are not limited to, company logos, team logos, straight lines, lines meeting at 90 degrees, semi-circular lines, spirals, symmetric and asymmetric shapes.

Tabs may be arranged in any way upon a mat. Tabs may be spaced in rows and/or columns of uniform spacing. Alternatively, tabs may be spaced at one spacing vertically and a second spacing horizontally. Additionally, tabs may be placed on a mat at random intervals.

Tabs may be oriented in any way upon a mat. Tabs may be vertical, horizontal or at any angle in-between. Further, tabs may vary in size or shape on a single mat.

Display items may include, but are not limited to, photographs, tickets, papers, identification cards, and paper currency.

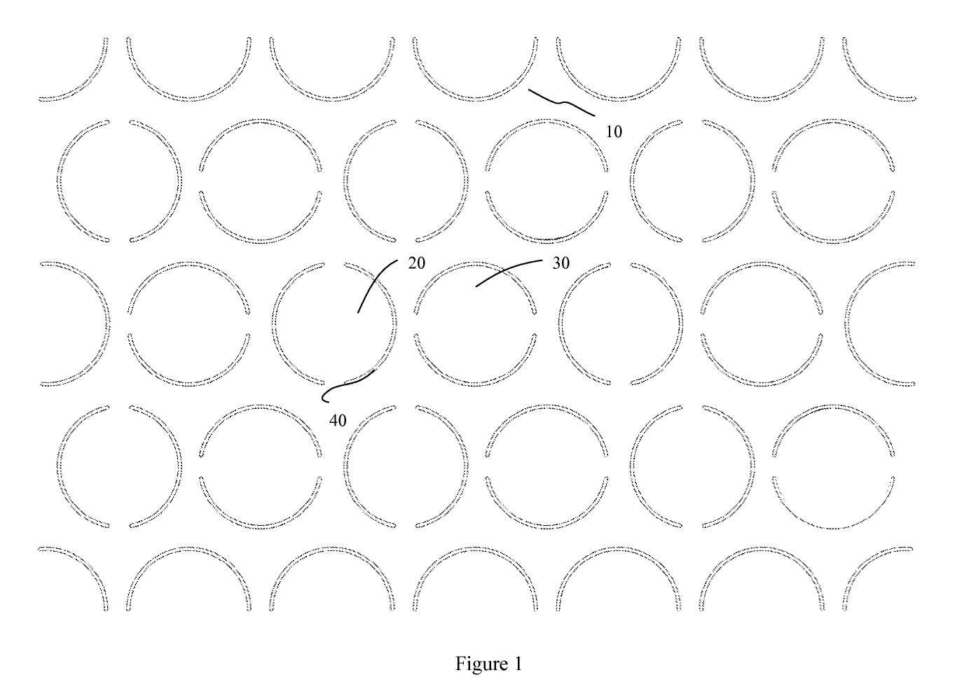

As shown in FIG. 1, tabs 20, 30 have been created in mat 10 by means of cuts 40. Tab 20 is created to have a horizontal orientation. Tab 30 is created to have a vertical orientation.

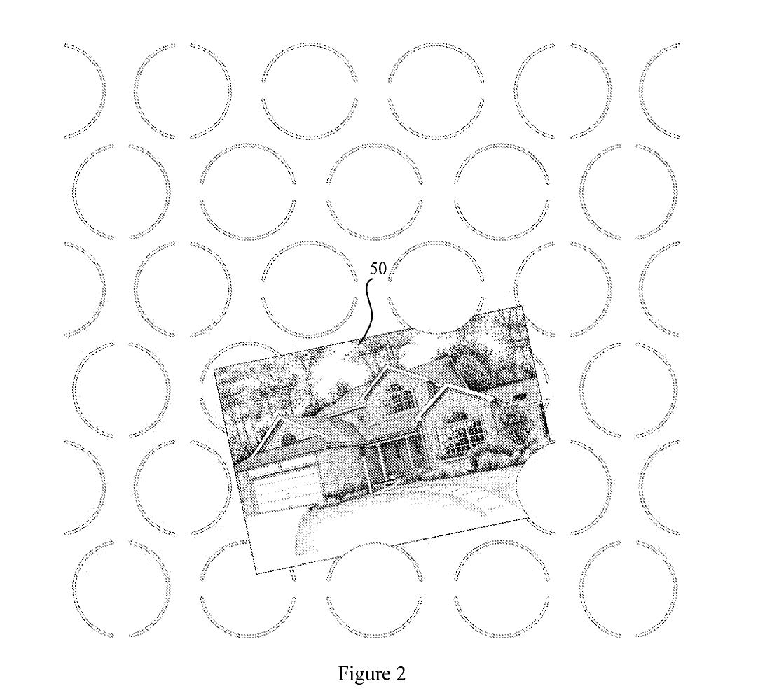

As shown in FIG. 2, display item 50 is held by tabs 20, 30. Display item 50 is held at one corner and two edges by tabs 20, 30. Due to the flexibility of the display item 50, display item 50 may pass through tab spacing smaller than its linear dimensions. After passing between the spacing of the tabs, display item 50 is allowed to flatten. Flattening causes display item 50 to be caught between the tabs and retained in place.

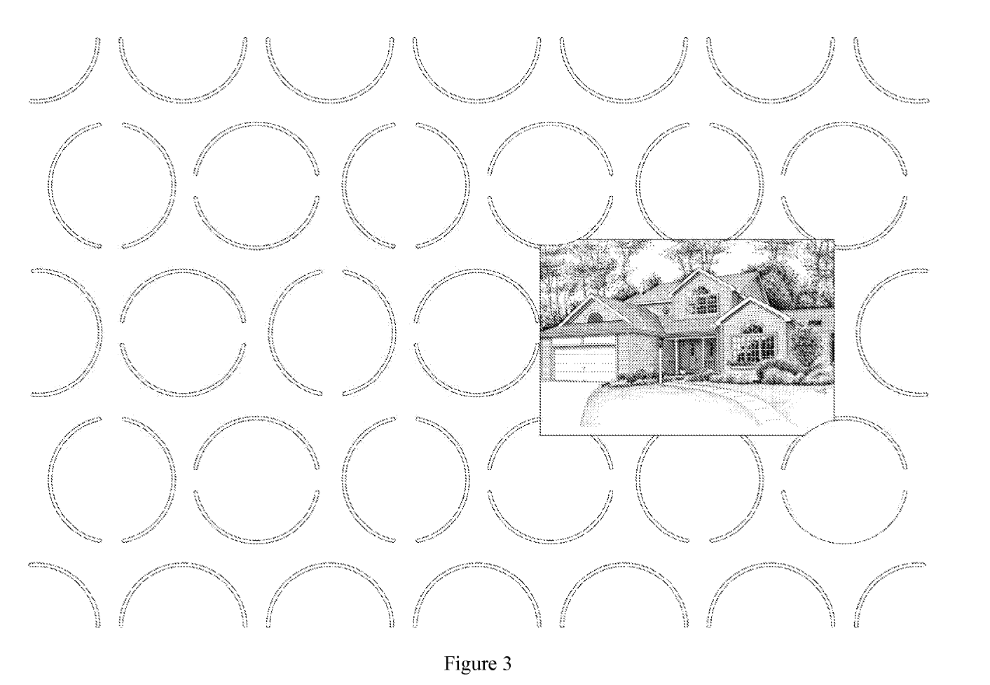

FIG. 3 shows an alternate method of holding display item 50 by two corners. Similar methods could be used with any number of corners and edges.

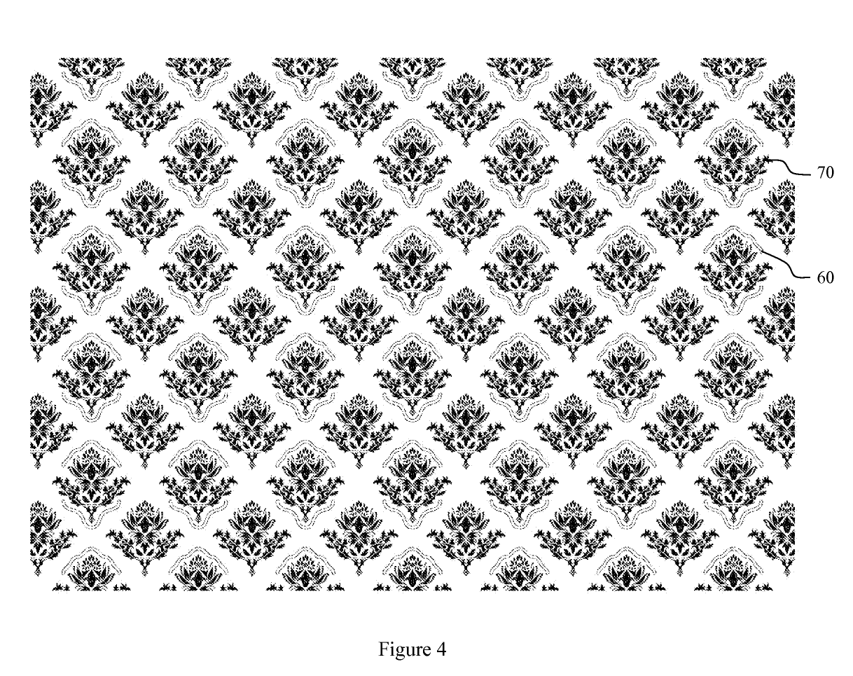

FIG. 4 shows an alternate shape and orientation of tabs 60. In this embodiment, all tabs are oriented in a vertical direction, either facing up or down. The shape of tab 60 follows the shape of ornamental design 70.

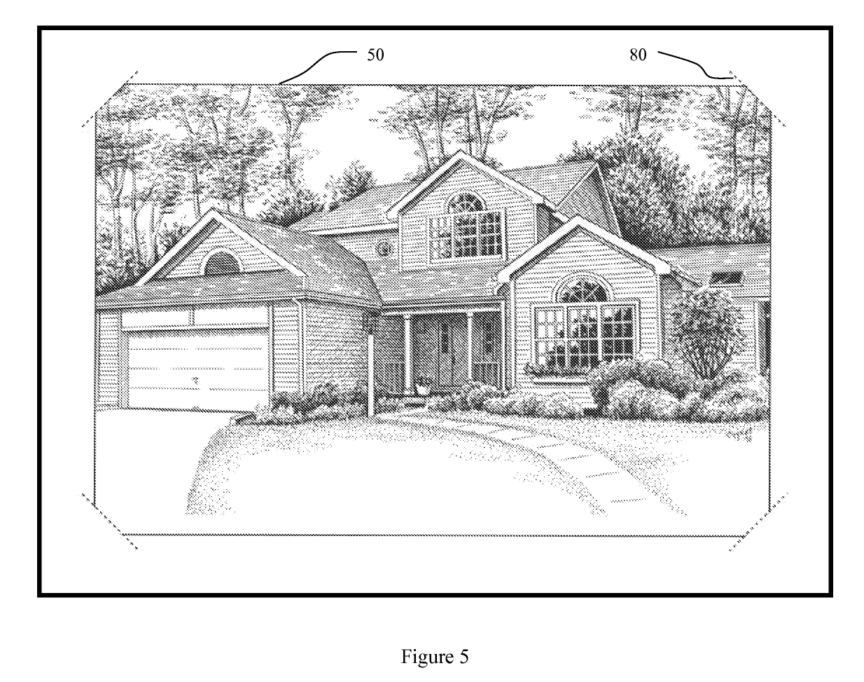

FIG. 5 shows an alternate shape and orientation of tabs 80. Tabs 80 are formed at 45 degrees. Each tab 80 is formed as a single line. Each corner of display item 50 is passed under a different tab 80. A similar result can be achieved using any number of corners of display item 50.

From the foregoing description, it is seen that the present invention provides a simple and efficient method to attach one or more display items to a display board or mat. Further, the invention simplifies the creation of such a collage because the display items are mounted to the display board from the front. Additionally, the display board may be used in conjunction with a standard or front loading picture frame, mounted to a backer board, secured in an album or covered with a transparent sleeve. When used in conjunction with a frame, the mat may serve as a standard framing board, the tabs preventing the display items for touching the pane of the picture frame.

Although particular embodiments of the invention have been illustrated and described, various changes may be made in the form, construction and arrangement of the parts herein, without sacrificing any of its advantages. It is understood that all matter herein is to be interpreted as illustrative and not in any limiting sense and it is intended to cover in the appended claims such changes and modifications as come within the spirit and scope of the invention.

1. A display device comprising:
a display board;
a plurality of tabs created from the display board and remaining partially attached thereto;
the tabs capable of retaining a display item;
the plurality of tabs created by removing portions of the display board;
the removed portions of the display board having a width greater than the display item.

2. The device of claim 1, wherein the removed portions of the display board are created from one of the group of: perforating, die-cutting and laser cutting.

3. The device of claim 1, wherein the tabs are vertically oriented.

4. The device of claim 1, wherein the tabs are horizontally oriented.

5. The device of claim 1, wherein the tabs are both vertically and horizontally oriented.

6. The device of claim 1, wherein the tabs are uniformly spaced vertically.

7. The device of claim 1, wherein the tabs are uniformly spaced horizontally.

8. The device of claim 1, wherein the tabs are uniformly spaced vertically and horizontally;
the horizontal spacing being different than the vertical spacing.

9. The device of claim 1, wherein the tabs are shaped as logos.

10. The device of claim 1, wherein the tabs are not identical to each other in shape.

11. The device of claim 1, wherein the display device is placed within a frame.

12. A display device comprising:
a display board;
a plurality of tabs created from the display board and remaining partially attached thereto;
the tabs capable of retaining a plurality of display items;
the plurality of tabs created by removing portions of the display board;
the removed portions of the display board having a width greater than the display item.

13. The device of claim 12, wherein the removed portions of the display board are created from one of the group of: perforating, die-cutting and laser cutting.

14. The device of claim 12, wherein the tabs are both vertically and horizontally oriented.

15. The device of claim 12, wherein the tabs are uniformly spaced vertically.

16. The device of claim 12, wherein the tabs are uniformly spaced horizontally.

17. The device of claim 12, wherein the tabs are uniformly spaced vertically and horizontally;
the horizontal spacing being different than the vertical spacing.

18. The device of claim 12, wherein the tabs are shaped as logos.

19. The device of claim 12, wherein the tabs are not identical to each other in shape.

20. The device of claim 12, wherein the display device is placed within a frame.
